(19) United States
(12) Patent Application Publication
(10) Pub. No.: US 2019/0156666 A1
(43) Pub. Date: May 23, 2019

(54) DRIVER ASSISTANCE SYSTEM FOR A VEHICLE

(71) Applicant: DAIMLER AG, Stuttgart (DE)

(72) Inventors: Stefan BECKMANN, Stuttgart (DE); Daniel BETZ, Rottenburg-Seebronn (DE); Stefan BÖHLER, Stuttgart (DE); Joseph FAGAN, Santa Clara, CA (US); Michele Domenico JAUCH-PAGANETTI, Giubiasco (CH); Frederic LATINO, Vernate (CH); Christian PECHER, Selb (DE); Marco PLEWE, Sunnyvale, CA (US); Klaus ROGGE, Sindelfingen (DE); Francesca SANGALLI, San Fermo Della Battagli (IT); Vera SCHMIDT, Böblingen (DE); Daniel Steffen SETZ, Böblingen (DE)

(21) Appl. No.: 16/091,663

(22) PCT Filed: Mar. 27, 2017
(86) PCT No.: PCT/EP2017/000371

§ 371 Date: Oct. 5, 2018

(30) Foreign Application Priority Data
Apr. 7, 2016 (DE) 10 2016 004 175.7

(51) Int. Cl. G08G 1/0967; G08G 1/16

(52) U.S. Cl. CPC G08G 1/0967; G08G 1/16

(57) ABSTRACT

A driver assistance system for a vehicle uses sensor data, which are provided from monitoring of the environment of the vehicle. The driver assistance system has a processing unit for processing the sensor data and a display device for displaying the processed sensor data. The environment of the vehicle is displayed as a light strip using the display device. Furthermore, an object in the environment of the vehicle is represented by a section on the light strip, wherein the section has a first light characteristic.

### BACKGROUND AND SUMMARY OF THE INVENTION

Exemplary embodiments of the invention relate to a driver assistance system for a vehicle.

Known driver assistance systems depict traffic situations based on positions of the surrounding traffic determined by vehicle sensors on a display. These systems have hitherto been limited to depiction on a display means.

Exemplary embodiment of the present invention are directed to an improved driver assistance system that can depict the dangerous situations in a vehicle environment, and the dangerous situation can be reliably interpreted by a driver or an automated system.

A driver assistance system for a vehicle is disclosed. For this purpose, the driver assistance system comprises sensor data that are provided from monitoring the environment or the surroundings of the vehicle. The driver assistance system furthermore comprises a processing unit for processing the sensor data, and a display device for depicting the processed sensor data. In this case, the display device depicts the environment of the vehicle as a light strip. Furthermore, an object in the environment of the vehicle is represented by a portion on the light strip, the portion having a first light characteristic.

In this case, the terms “environment” and “surroundings” are to be considered equivalent and constitute a limited region around the vehicle in which the driver assistance system acts. The size of the environment may also be variable and adjusted to the speed of the vehicle for example. The driver assistance system thus requires a wider environment at high speeds, for example on a motorway, and a smaller environment at low speeds, for example in urban traffic.

The present invention provides for the vehicle surroundings or traffic situation identified by the driver assistance system to be visualized in the form of a light strip in the interior of the vehicle. Accordingly, depiction of the traffic situation of the vehicle surroundings in the form of a lighting effect in the interior of the vehicle is disclosed, which depiction is also understood to be a “safety shield/proximity” solution.

In an embodiment of the driver assistance system according to the invention, it is possible for the light strip to be formed by a plurality of actuatable light sources, the light strip being formed as an LED strip, as a matrix or as a display means.

In this case, “light strip” is to be understood as any display format that extends in the longitudinal direction and that can emit light, and in the case of which specific portions of the light strip can be varied with respect to a light characteristic. The variable portions of the light strip are preferably provided with individually controllable electric illumination elements as a light source. The “light strip” therefore has an extensive geometry in the longitudinal direction and comprises illumination means that can be deliberately controlled such that different portions of the light strip may have different illumination characteristics. The same applies to an “LED strip”, which is a particular embodiment of a light strip, the illumination means, or illumination elements being designed as LEDs.

By means of corresponding actuation, a LED matrix or a display means may also represent a light strip. The proposed embodiment can be achieved in a simple manner by using a dynamically actuatable light source (e.g. light strip, LED strip, LED matrix or display means) in the interior of the vehicle, and intelligent connection to driver assistance sensor systems or other sensor systems that form images of the surroundings, and subsequent processing controllers.

Furthermore, it is possible, in a preferred embodiment, for the light strip to reproduce a positionally accurate representation of the environment of the vehicle with respect to the vehicle.

This means, for example, that an object identified on the right-hand side with respect to a vehicle in which the driver assistance system according to the invention is installed also results in a representation of the identified object in a right-hand position of the light strip in the lighting situation of the light strip. In addition to “right-hand” and “left-hand”, it is also possible to identify “front” and “rear” as positions of objects. In this case, “objects” are, for example, further vehicles on the road, both travelling and stationary, and other objects, for example crash barriers, trees or the like on the edge of the road, or stray objects on the road.

It is particularly advantageous for the light strip to form a geometrically closed shape. It is thus possible to schematically reproduce the outside geometry of the vehicle in order to represent the environment in a positionally accurate manner on the light strip in the vehicle. In this case, the driver can identify, without further analysis, the direction (“front”, “rear”, right-hand”, “left-hand” or corresponding intermediate states such as “right-hand front”, etc.) from which a dangerous situation has been identified. The driver can react intuitively, or the driver assistance system can correct the direction of travel of the vehicle in a semi-automatic or fully automatic manner.

It is particularly advantageous, according to a further embodiment, for a dangerous situation with respect to an object in the environment of the vehicle to be displayed on the light strip by means of a second light characteristic. In this case, “light characteristic” may refer to a color, for example blue for no danger and red for a dangerous situation. Furthermore, the “light characteristic” may for example refer to the type of light reproduction, for example constant light for an identified object but no dangerous situation, and flashing light for an identified object that is a danger because, for example, the relative spacing between the vehicle in question and the identified object is reducing.

Overall, the driver assistance system according to the invention depicts the current traffic situation using light in the interior of the vehicle. This provides the driver with additional information regarding the manner in which the current traffic situation should be assessed. In addition, critical situations can be highlighted by means of visual support, e.g., by highlighted depiction of vehicles not adhering to a limit spacing or moving at critical speed differences, for example using colors, bright portions, flashing, etc. Furthermore, the mode of operation of assistance systems can thus also be brought to life and the level of acceptance of the systems can thus be increased.

The driver assistance systems according to the invention use sensor data provided from monitoring the environment of the vehicle, in order to analyze and evaluate said sensor data using a processing unit. The result thereof can be used for actuating a light strip.

The light strip advantageously comprises a plurality of illumination elements in order to thus be able to clearly depict an identified position of an object. Turning off one or more illumination elements may also constitute an illumination characteristic which represents a situation in which no object has been identified in the environment of the vehicle. A matrix, such as an LED matrix, may also be used as the light strip, since the actuated LEDs can assume the form of a strip which may for example be U-shaped or be a closed shape such as a rectangle.

The processing unit may comprise a controller. In this case, the task of the controller, for example an IDC (intelligent drive control) is to evaluate the different sensor signals (e.g., radar sensors, camera sensors, etc.). This results in identification of the driving situation, i.e., information regarding a vehicle environment such as the number, position, and (relative) speed of the surrounding vehicles and objects. This information can be used, in a general manner, for regulating the driver assistance systems, for example for longitudinal and transverse guidance, or even semi-automatic or fully automatic driving.

In an embodiment, various elements in the vehicle are preferably interconnected to form an operative chain in order to provide a driver assistance system. The operative chain comprises, for example, the sensors for detecting the vehicle surroundings. Furthermore, sensor data obtained are fed into a controller or IDC. The data reach a control unit of an ambient lighting system via an ethernet connection for example. The data can furthermore be conducted to a light strip via a CAN bus.

In detail, the following possible processing steps result:

1. detecting the vehicle surroundings/traffic situation in a controller, e.g., IDC, although any sensor fusion can be used in principle;
2. transmitting the data of the identified objects and the position and speed thereof to the control unit of an ambient lighting system and of the light strip;
3. evaluating the data and “converting” the position and speed information into a “projection”; and
4. emitting the projection at a light strip as a light source (linear light strip, LED strip, matrix, display means, or the like), i.e., temporally controlled regulation of color and brightness of the individual illumination elements.

The proposed lighting effect of the driver assistance system according to the invention results in advantages such as increased concentration and thus increased driving safety. Increased driving comfort, and the technology being brought to life, being attractive and being transparent also result.

Further advantages, features and details of the invention can be found in the following description of a preferred embodiment, and with reference to the drawings. The features and combinations of features mentioned above in the description and the features and combinations of features mentioned below in the description of the figures and/or shown in the figures alone can be used not only in the combination specified in each case, but also in other combinations or in isolation, without departing from the scope of the invention.

### BRIEF DESCRIPTION OF THE DRAWING FIGURES

In the drawings:

FIG. 1 shows a first traffic situation, by way of example, and an embodiment for an associated light situation of a light strip;

FIG. 2 shows a second traffic situation, by way of example, and an embodiment for an associated light situation of a light strip;

FIG. 3 shows a third traffic situation, by way of example, and an embodiment for an associated light situation of a light strip; and

FIG. 4 shows a fourth traffic situation, by way of example, and an embodiment for an associated light situation of a light strip.

### DETAILED DESCRIPTION

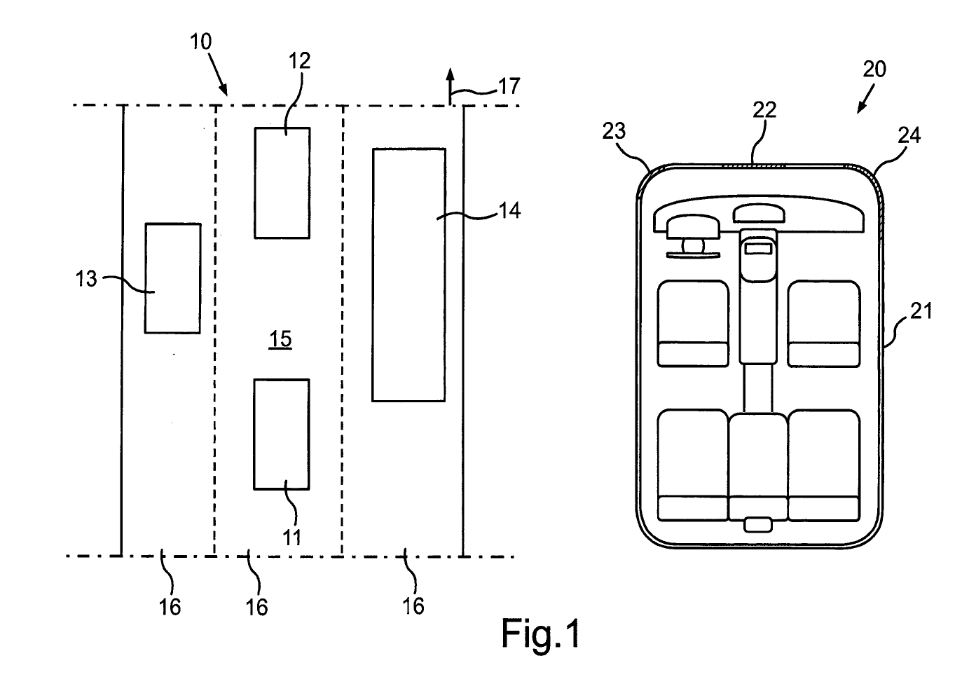

FIGS. 1 to 4 each show, on the left-hand side thereof, different traffic situations 10 given by way of example. On the right-hand side thereof, FIGS. 1 to 4 each show embodiments for a display of a display device 20 comprising a light strip 21 in a corresponding light situation, which display corresponds to the traffic situation 10.

FIGS. 1 to 4 each show four vehicles 11, 12, 13, 14 driving on a motorway having three lanes 16. In this case, a driver assistance system according to the invention, which uses sensor data from an environment 15 of the vehicle 11 in order to monitor the environment 15 of the vehicle, is installed in vehicle 11, which is in the middle lane 16. The sensor data are first analyzed and evaluated by a processing unit, and the result is depicted visually on the display device 20 using the light strip 21. The interior of the vehicle 11 is also depicted schematically in the interior of the light strip 21, but this is merely optional. In the present embodiment, this depiction is intended to show that, when the vehicles 11, 12, 13, 14 have a direction of travel 17, the representation of the environment 15 of the vehicle 11 is also displayed on the light strip 21 in a positionally accurate manner, on the basis of the direction of travel 17.

The light situations shown by way of example in FIGS. 1 to 4 are to be considered one of the possible embodiments and may be intensified for example depending on the driving mode or environmental conditions, e.g. rain, Sport+, etc. Moreover, the light situations can be parameterized in a general manner, for example using the parameter color, brightness, illumination frequency and the like.

On the right-hand side of FIGS. 1 to 4, the identified objects 12, 13, 14 in the environment 15 of the vehicle 11, which, in the present example, are vehicles 12, 13, 14 on the lane 16, are each represented by a portion 22, 23, 24 on the light strip 21. In this case, portion 22 of the light strip represents vehicle 12, portion 23 represents vehicle 13, and portion 24 represents vehicle 14.

The light strip 21 in FIGS. 1 to 4 furthermore gives a positionally accurate representation of the environment 15 of the vehicle 11 from the viewpoint of the driver of the vehicle 11. Furthermore, the light strip 21 is formed as a geometrically closed shape, in this case an angular shape having rounded corners, the shape schematically reproducing the contour of the vehicle 11.

FIG. 1 shows a first traffic situation, by way of example, in the case of normal motorway traffic, the vehicles 11, 12, 13, 14 being distributed over three lanes 16 and travelling at a uniform speed and a sufficient mutual vehicle spacing.

The light situation in vehicle 11 shows that the entire light strip 21 is radiating in a “steady” color. The vehicles 12, 13, 14 identified by the vehicle sensors are shown according to the position thereof. A “neutral” color, for example blue, is selected for displaying said vehicles 12, 13, 14 at the positions 22, 23, 24 because a dangerous situation is not identified.

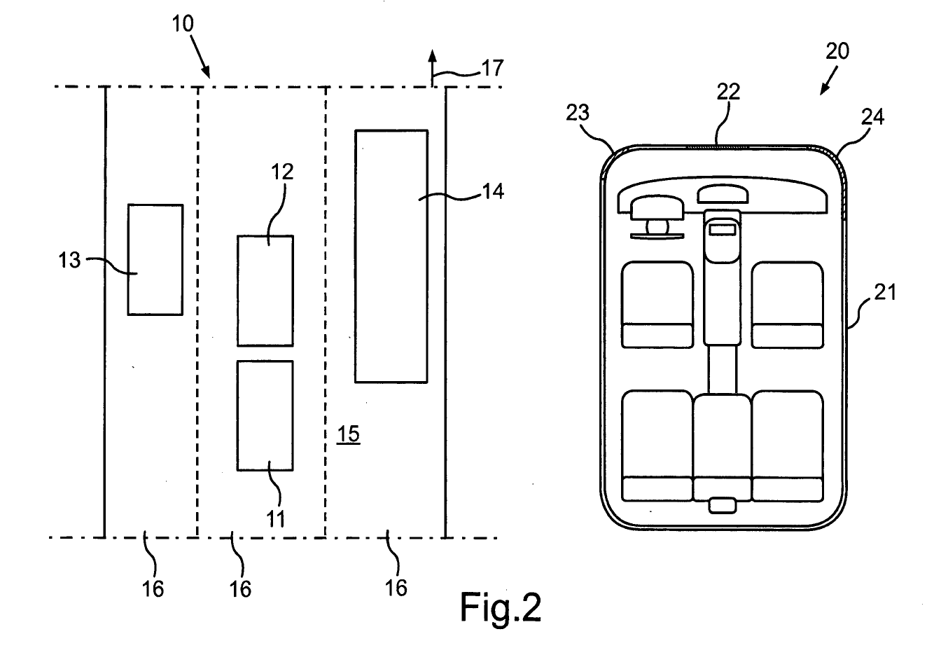

FIG. 2 shows a second traffic situation, by way of example, in the case of normal motorway traffic, the vehicles 11, 12, 13, 14 being distributed over three lanes 16 and travelling at a uniform speed. However, in this example the vehicle spacing between vehicle 11 and vehicle 12 is critical.

In the light situation in vehicle 11, the entire light strip 21 initially radiates in a “steady” color in portions 22, 23, 24. The vehicles 12, 13, 14 identified by the vehicle sensors are shown according to the position thereof. A “neutral” color is selected for vehicle 13 and vehicle 14. Vehicle 12 is at a critical spacing and is shown on the light strip 21, in a corresponding portion 22, in a signal color. Compared with FIG. 1, the light strip 21 now shows a different color at the position of vehicle 12 from that at the positions of vehicles 13 and 14. The color is selected as the signal color, for example red.

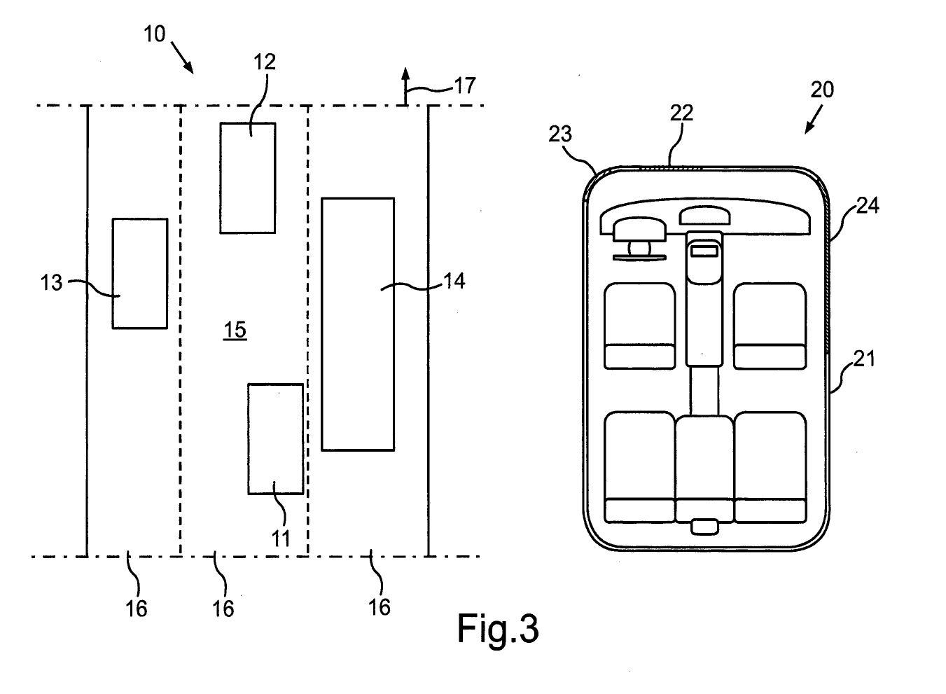

FIG. 3 shows a third traffic situation, by way of example, in the case of normal motorway traffic, the vehicles 11, 12, 13, 14 being distributed over three lanes 16 and travelling at a uniform speed. In this case, the vehicle spacing between vehicle 11 and vehicle 14 is critical.

The light situation in vehicle 11 reflects said critical situation in that the entire light strip 21 initially radiates in a “steady” color, for example blue, in portions 22, 23, 24. In this case, the vehicles 12 and 13 identified by the vehicle sensors are shown according to the position thereof as portions 22, 23. A “neutral” color, for example blue, is selected for said vehicles 12 and 13. However, vehicle 14 is at a critical spacing from vehicle 11 and is therefore represented in a signal color, for example red, in portion 24.

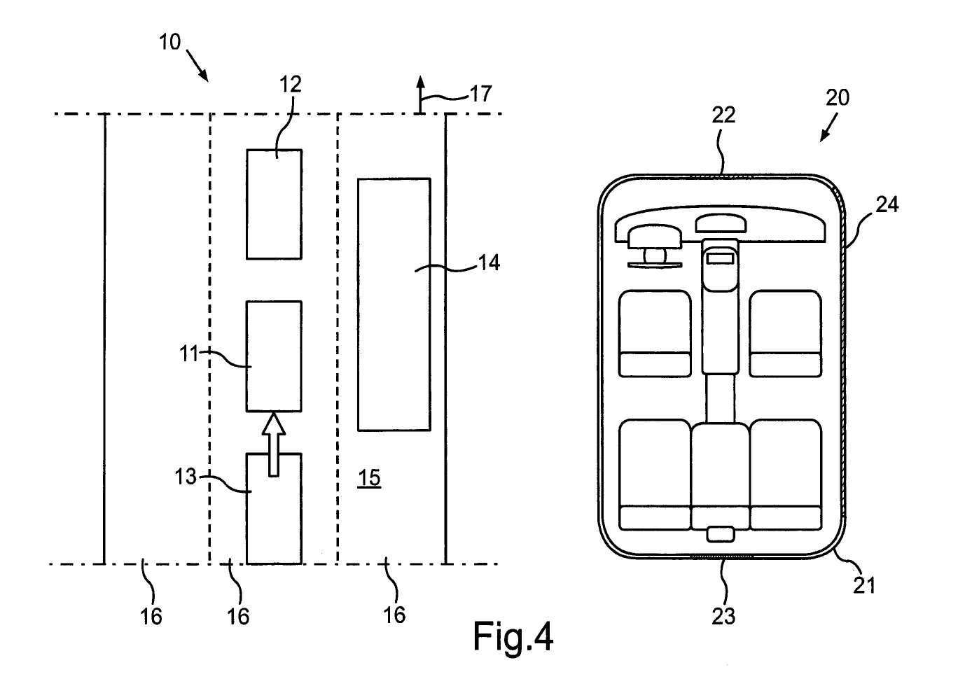

FIG. 4 shows a fourth traffic situation, by way of example, in the case of normal motorway traffic, the vehicles 11, 12, 13, 14 being distributed over three lanes 16 and travelling at a uniform speed. However, vehicle 13 is rapidly approaching vehicle 11.

The light situation in vehicle 11 reflects the critical situation. The entire light strip 21 initially radiates in a “steady” color, for example blue, at positions 22, 23, 24. The vehicles 12 and 14 identified by the vehicle sensors are shown according to the position thereof. In this case, a “neutral” or “steady” color, for example blue, is selected for vehicles 12 and 14. Vehicle 13 is at a critical spacing or has a high relative speed and is shown in a signal color, for example red, as portion 23. The light strip 21 thus displays a dangerous situation involving an identified vehicle 13 in a different illumination characteristic from that in the portions comprising the identified vehicles 12, 14 or objects that do not pose any danger.

In the case of the above embodiments, a danger need not result from the identified vehicle or object itself, but rather the driver's own vehicle 11 approaching a vehicle or object is also considered a dangerous situation, as shown in FIG. 3. Furthermore, it is also possible to combine color characteristics. In a dangerous situation, it is thus possible, for example, to also use flashing of the corresponding portion on the light strip 21 or an increase in the luminosity or brightness of the illumination elements, in addition to coloring. An increased frequency of a flashing portion can also increase awareness of a dangerous situation.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-5. (canceled)

6. A driver assistance system for a vehicle, comprising
a processor configured to process sensor data provided from monitoring an exterior environment of the vehicle; and
a display configured to depict the processed sensor data,
wherein the display depicts the exterior environment of the vehicle as a light strip, and
wherein an object in the exterior environment of the vehicle is represented by a portion on the light strip, the portion having a first light characteristic.

7. The driver assistance system of claim 6, wherein the light strip is formed by a plurality of actuatable light sources, and the light strip is an LED strip, as a matrix or as a display means.

8. The driver assistance system of claim 6, wherein the light strip reproduces a positionally accurate representation of the exterior environment of the vehicle with respect to the vehicle.

9. The driver assistance system of claim 6, wherein the light strip has a geometrically closed shape.

10. The driver assistance system of claim 6, wherein a dangerous situation with respect to an object in the external environment of the vehicle is displayed on the light strip using a second light characteristic.

11. A method for operating a driver assistance system of a vehicle, the method comprising:
monitoring, using at least one sensor of the vehicle, an exterior environment of the vehicle to produce sensor data;
processing, by a processor of the vehicle, the sensor data to produce processed sensor data; and
depicting, on a display, the processed sensor data,
wherein the display depicts the exterior environment of the vehicle as a light strip, and
wherein an object in the exterior environment of the vehicle is represented by a portion on the light strip, the portion having a first light characteristic.

12. The method of claim 11, wherein the light strip is formed by a plurality of actuatable light sources, and the light strip is an LED strip, as a matrix or as a display means.

13. The method of claim 11, wherein the light strip reproduces a positionally accurate representation of the exterior environment of the vehicle with respect to the vehicle.

14. The method of claim 11, wherein the light strip has a geometrically closed shape.

15. The method of claim 11, wherein responsive to detection, based on the sensor data, of a dangerous situation with respect to an object in the external environment of the vehicle, the method further comprises:
using a second light characteristic to display the dangerous situation on the light strip.
